(19) United States
(12) Patent Application Publication
(10) Pub. No.: US 2002/0030606 A1
(43) Pub. Date: Mar. 14, 2002

(54) Wireless drive-by meter status system

(75) Inventors: Greg Chauvin, Hatchett Lake (CA); Neil Erskine, Halifax (CA); Brent Alcorn, Salem, MA (US)

Correspondence Address: Hayes, Soloway, Hennessey & Hage, 175 Canal Street, Manchester, NH, 03101, US

(73) Assignee: J.J. MacKay Canada Limited

(21) Appl. No.: 09/952,233

(22) Filed: Sep. 12, 2001

(30) Foreign Application Priority Data
Sep. 12, 2000 (CA) 2,318,645

(51) Int. Cl. G08G 1/14

(52) U.S. Cl. 340/932.2; 340/540

(57) ABSTRACT

A wireless drive-by meter status system for use by parking enforcement officers who are patrolling a zone or area in a motorized vehicle is described. The system comprises a vehicle in which is placed a mobile unit including a transceiver, an antenna as well as a status display means, and one or more remote units including transceivers each paired with one or more electronic meters. The remote units may be mounted inside the meter housings, which in turn are mounted on posts. In operation the vehicle antenna transmits a wake-up or trigger signal using a focused beam of modulated IR, ultrasonic or RF energy, which can be detected by any remote units found in the beam path. This beam is detected by low power circuits located in the remote unit and causes the remote unit processing means to wake up, determine the meter status and activate an RF transceiver which transmits back to the mobile unit a short data burst that includes the unique ID and status of the meter which includes “EXPIRED” or “NOT-EXPIRED” state. The mobile transceiver unit captures and logs all responses from remote units that responded to the trigger signal, and if an “EXPIRED” state exists, it notifies the driver either by simple light or audible signal that a responding meter is expired. The driver, once notified simply has to note if a vehicle is present in the space associated with the notifying meter.

### FIELD OF THE INVENTION

The invention relates generally to parking meters and more particularly to a method and apparatus for determining the status of parking meters.

### BACKGROUND OF THE INVENTION

Parking enforcement in many cities and municipalities is typically carried out by enforcement staff or personnel. Proper enforcement ensures that parking spaces, which is usually limited and typically used for short-tern parking, is properly used by the public, and paid for. These enforcement staff must be physically present and on street to both witness the offence (parking violation) and also issue the ticket or citation which is typically placed on the driver's side window under the wiper. The enforcement staff can either walk a particular city zone or area provided that the area is relatively small and parking is quite concentrated, but where that is not the case, the enforcement staff will patrol a zone or area in a motorized vehicle. This is also the preferred mode of transport during inclement weather. The disadvantage of having enforcement staff in motorized vehicles as opposed to on foot is that the increased distance from the parking meter post sometimes makes it difficult to confirm or verify that a meter is expired. Glare, rain/drizzle, scratched or worn domes, graffiti and other obstructions that block the enforcement officer's view further increase this viewing difficulty. In many cases verification can only be made by the parking enforcement officer (PEO) exiting from the vehicle and approaching the meter.

A key requirement of an improved enforcement system sought by parking authorities is to be able to reliably detect violated parking meters by PEOs from a moving vehicle, day or night, in a wide variety of climate conditions.

In current systems that have mechanical meters, PEOs visually inspect every meter on their route where a vehicle is present by referring to the RED “In Violation” FLAG to detect violated parking meter. The RED “In Violation” FLAGS are highly visible from some distance away and therefore meet most basic requirements. However, parking meter manufacturers have now discontinued the production of the older styled mechanical parking meters and mechanical replacement parts for existing meters are becoming increasingly hard to find.

Mechanical meters are now being replaced by electronic parking meters that are generally more dependable, accurate and versatile. However, in an attempt to simulate the mechanical flag, the electronic meters display an electronic “In Violation” flag by using either super bright LEDs or red LCD shutters which light-up when the meter is in violation. Though these electronic flags are visible under most normal conditions, they still have the main weakness that, while driving their vehicles, the PEOs are obliged to take their eyes off of the road long enough to recognize the flag in order to carry out enforcement. In some cases the PEOs still cannot ascertain the meter status and the officer must exit the vehicle to do a closer inspection only to find that the meter is not in violation. In many cases the PEOs may choose to ignore hard to read meters, possibly forgoing enforcement revenues and causing the meters to be poorly managed.

A number of parking enforcement systems have been developed in which “in violation” information is obtained from electronic parking meters. In U.S. Pat. No. 4,356,903, which issued to Lemelson et al on Nov. 2, 1982, a system is described in which a short wave code indicating that time has run out on the meter is generated and transmitted to a monitor station or a portable device carried by an attendant. In U.S. Pat. No. 4,823,928, which issued to Speas on Apr. 25, 1989, a system is described in which an auditor may be connected to a meter by a direct cable link or by infrared to extract data from the parking meter. In U.S. Pat. No. 5,266,947, which issued to Fujiwara et al on Nov. 30, 1993, a system is described in which transmissions indicating the time remaining on a meter or that the time on a meter has expired may take place between a meter and a portable unit. In U.S. Pat. No. 5,407,049, which issued to Jacobs on Apr. 18, 1995, a system is described in which the meter includes an IR transceiver for enabling parking authority personnel to communicate with the meter. In U.S. Pat. No. 5,740,050, which issued to Ward, II on Apr. 14, 1998, a system is described in which an interface such as infrared, hard wired or other wireless media is used to communicate between a citation writing system and a meter to download data such as the status of the meter. However, all of these systems are complex and do not afford the flexibility required by a PEO to quickly and effectively check a large number of meters while driving by in order to determine the meters that are in violation, thereby allowing the immediate issuance of a citation.

Therefore, there is a need for a method and apparatus for detecting “in violation” meters for both day and night enforcement, which requires minimal diversion of the PEO's attention.

### SUMMARY OF THE INVENTION

The invention is directed to a system for remotely determining the status of parking meters having remote units associated with the meters and a mobile unit for interrogating the remote units. The remote unit comprises a receiver for receiving a trigger or wake-up signal, a transceiver for transmitting and receiving command signals and a controller for operating the receiver and the transceiver. The mobile unit comprises a transmitter for transmitting the trigger or wakeup signal, a transceiver for transmitting and receiving command signals, a display for providing an indication of the status of a meter, and a controller for operating the transmitter, the transceiver and the display.

In accordance with another aspect of the invention, the remote unit may further comprise a memory for storing meter status and meter identifier data for the meter associated with the remote unit. Additionally, the mobile unit may further comprise a memory coupled to the controller for storing data in the mobile unit, and the system may include a back-end data processing system for transmitting data to the mobile unit and for receiving data from the mobile unit.

With regard to a further aspect of the invention, the remote unit receiver is an infrared receiver and the mobile unit transmitter is an infrared transmitter. The infrared transmitter may comprise an infrared controller and an infrared emitter array for transmitting one or more focused infrared beams in one or more different directions. In addition, the remote transceiver and the mobile transceiver may be RF transceivers.

In accordance with another aspect of this invention, the display may comprise light and audio elements for indicating meter status and control keys for interfacing with the controller.

With respect to a specific aspect of this invention, the remote units are located in the housings of the meters with which they are associated and the mobile unit is located in a vehicle.

In accordance with the present invention, the method of determining the status of parking meters in a system wherein a number of remote units are associated with the meters and wherein a mobile unit is used to interrogate the remote units comprises transmitting a wake-up signal to a remote unit from the mobile unit, receiving the meter status signal from the remote unit by the mobile unit and displaying the status of the meter at the mobile unit.

In accordance with another aspect of this invention, the mobile unit may transmit a status request signal to the remote unit after the wake-up signal and a status acknowledged signal after the meter status signal is received.

Regarding specific aspects of the invention, a meter unique identifier signal is transmitted with the status signal by RF. In addition, the wake-up signal may be a focused infrared beam, ultrasonic beam or RF beam.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a schematic of a system in accordance with the present invention;

FIG. 2 is a block diagram of the system;

FIG. 3 is a block diagram of the remote transceiver unit mounted in a parking meter;

FIG. 4 is a block diagram of the mobile transceiver unit mounted in a PEO's vehicle;

FIG. 5 schematically illustrates the system in operation;

FIG. 6 is a flow chart of the operation of the mobile transceiver unit;

FIG. 7 is a flow chart of the operation of the remote transceiver unit; and

FIG. 8 is a schematic of the system with a back-end computer system.

### DETAILED DESCRIPTION OF THE INVENTION

According to the present invention, described herein, a wireless drive-by meter status system for use by parking enforcement officers who are patrolling a zone or area in a motorized vehicle is provided. The wireless drive-by meter status system comprises a vehicle in which is placed a mobile unit including a transceiver, an antenna as well as a status display means, and one or more remote units having transceivers each paired with one or more electronic meters. The remote units may be mounted inside the meter housings, which in turn are mounted on posts.

In operation the equipped vehicle traverses a specific zone or area in which will be found one or more such equipped parking meters. The vehicle antenna transmits a wake-up or trigger signal using a focused beam of modulated IR, Ultrasonic or RF energy which can be detected by any remote units found in the beam path, which changes as the vehicle moves forward. The trigger beam is directed at a direction relative to the vehicle travel direction and effective distance of the trigger beam such that no more than two meters on a single pole fall into the trigger beam. This ensures that the driver will not receive responses from meters outside of those responsible for the current parking spaces that the vehicle is driving by. This focused beam is detected by low power circuits located in the remote parking meter, which are specifically designed to continuously detect and demodulate the specified IR, ultrasonic or RF trigger signal. The detected signal causes the remote unit processing means to wake up, determine the meter status and activate an RF transceiver unit which transmits back to the mobile unit a short data burst that includes it's unique ID and status which includes “EXPIRED” or “NOT-EXPIRED” state. The mobile transceiver unit captures and logs all responses from remote units that responded to the trigger signal, and if an “EXPIRED” state exists, it notifies the driver either by simple light or audible signal that a responding meter is expired. The driver, once notified simply has to note if a vehicle is present in the space associated with the notifying meter.

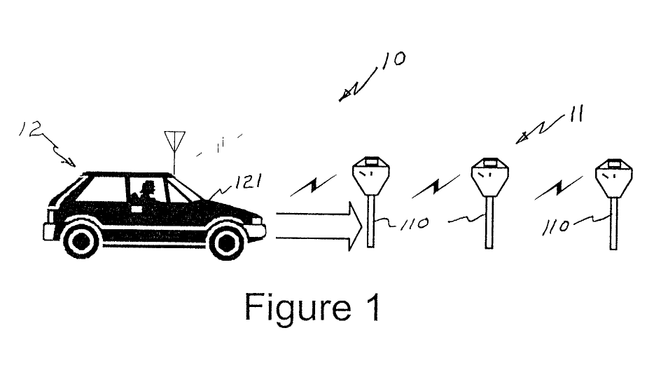

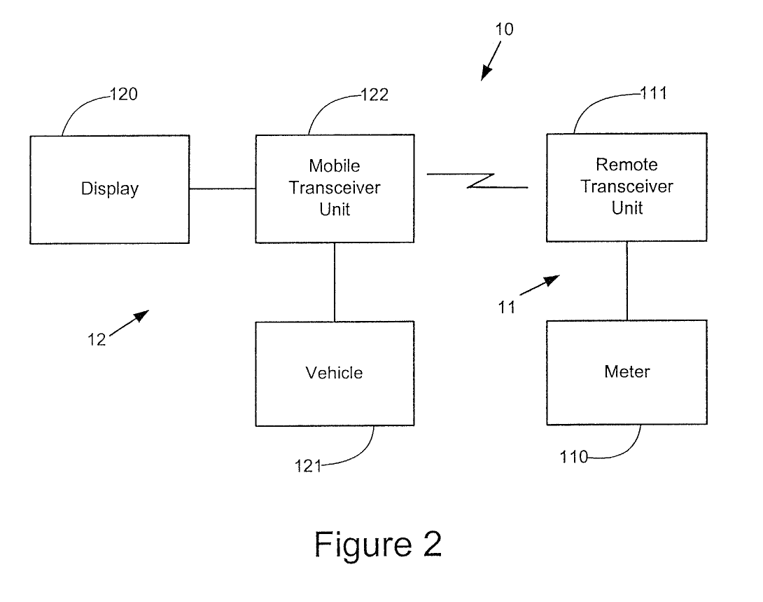

The Wireless Drive-by Meter Status System (WDMSS) 10 in accordance with the present invention will be described in conjunction with the FIG. 1 schematic and the block diagram illustrated in FIG. 2. The system 10 includes a remote assembly 11 and a mobile assembly 12. Remote assembly 11 comprises a parking meter mechanism 110 that accommodates a Remote Transceiver Unit (RTU) 111 located in the housing of the parking meter mechanism 110. RTU 111 is a wireless transceiver unit capable of interacting with the parking meter electronics to obtain the meter's status, and of communicating with the mobile assembly 12 to transmit the meter status to the mobile assembly 12. The mobile assembly 12 comprises of a display unit 120 that is wired to a Mobile Transceiver Unit (MTU) 122; the units may be mounted in a PEO's vehicle 121. MTU 122 is capable of wirelessly communicating with the remote assembly 11 to transmit a wake-up command and a status request command to the RTU 111 and to receive a meter status response from the RTU 111. In addition, the MTU 122 will then cause the display unit 120 to display the meter status. Meter status may include information about the meter such as low battery or other problems in addition to meter being in violation.

The display unit 120 may include a first light to indicate that the meter is “in violation” and a second light to indicate that the meter is not “in violation”. The lights may be accompanied by audio signals as well, allowing the PEO to determine status without having to watch for the lights. Alternately, the display unit 120 may be a portable hand-held computer (PDT), such as a DAP 9800, or a vehicle-dash mounted Personal Data Assistant (PDA), such as a Palm Pilot, wired to the MTU 122.

In operation, the PEO drives down a route with the MTU 122 powered-up. The MTU 122 will transmit a focused wake-up command signal towards meters 110 followed by a request status command signal. As the vehicle 121 passes the meters 110, the RTUs 111 in the meters 110 will be triggered to respond by the sequentially transmitting status response signals towards the PEO's vehicle 121. On receiving the status signal, the MTU 122 will activate the display 120 which will visually and, optionally, audibly indicate whether the meter 110 is “in violation” or not. When an “in violation” signal is detected, the PEO will note the presence or absence of a vehicle at the site, and will proceed to issue a citation when a vehicle is parked next to an “in violation” meter 110.

As a wake-up command signal to the RTU 111, the MTU 122 may transmit an intense, nearly continuous infrared (IR) modulated burst of IR light in a directed beam towards the meter 110. However, as an alternative, the wake-up command signal may be a focused beam of ultrasonic or RF energy. IR or ultrasonic signals are preferred since overall power consumption on the RTU 111 is much less for IR or ultrasonic systems. Also, it is much more difficult to focus an RF transmission so that only one or two meters will respond at a time.

The send status command signal generated by the MTU 122 and the status response signal generated by the RTU 111 are preferably RF signals; however, it is within the scope of the present invention to use some other form of wireless communication.

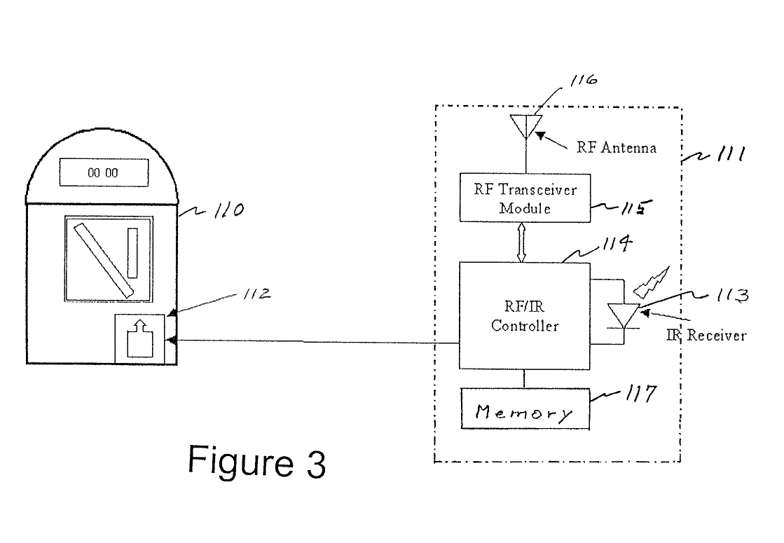

A block diagram of the preferred embodiment of a Remote Transceiver Unit (RTU) 111 in conjunction with a parking meter mechanism 110 is shown in FIG. 3. RTU 111 comprises hardware that is placed on the inside of the meter 110 housing to detect an IR trigger burst originating from the Mobile Transceiver Unit (MTU) 122, as well to transmit/receive RF signals to/from the MTU 122. The main components on the RTU 111 are an RF antenna 116, an RF transceiver module 115, an intelligent controller (processor) 114, a memory 117 and an IR receiver circuit 113. The IR circuit 113 is low powered since it is always active and is therefore a continuous load on the battery. The IR circuit 113 is used to detect the modulated IR light originating from the MTU 122. The IR receiver circuit 113 is a tuned circuit using a solid state PIN diode as the IR sensor and only accepts a specific modulation frequency. This accepted modulation frequency is selected such that the most common and obvious sources of modulated IR interference, such as TV/consumer electronic remote control devices, will be rejected.

The interface 112 between the meter 110 electronics and the RTU 111 consists of a cable with a male ‘RJ’ style telephone jack termination that plugs into a mating female expansion connector on a meter 110. The interface cable 112 carries the necessary signals between the meter 110 electronics and RTU 111 as well as power to RTU 111. When the meter 110 electronics is active, it will send the current meter status to RTU 111. The current meter status is stored in memory 117 together with the unique meter identifier. The meter status is kept in local memory 117 to allow the RTU 111 to respond much more quickly and efficiently, since the RTU 111 does not have to wake up the meter 110 mechanism to retrieve the meter status information.

The RTU 111 may consist of a printed circuit board (PCB) that is placed in the dome of the parking meter 110. All of the components of the RTU 111 are placed onto the underside of the PCB with the exception of the IR receiver 113 that is placed on the top-side of the PCB so that it can detect any IR transmissions that enter through the meter dome. A thick copper “strip-line” track etched into the circuit board will serve as antenna 116 that is not highly visible and cannot be easily damaged or broken.

Once the IR circuit 113 has been tripped by the correct IR modulation, the intelligent controller 114 on the RTU 111 will be activated. The controller 114 is an autonomous, low power microprocessor, which controls the response of the RTU 111 to external signals. On activation, and having determining that the IR circuit 113 was the source of the wake-up, it then activates the RF transceiver module's 115 receiver section. The purpose of doing this is to determine if a MTU 122 is in the vicinity by listening for a “send status” command signal being transmitted by the MTU 122. Since the RF transceiver module's 115 receiver consumes less power than the transmitter, this sequence reduces unnecessary RF transmissions, conserving battery power. If no command is detected after an appropriate time-out, the controller 114 will shut down the transceiver 115, re-trigger the IR receiver circuit 113, and then go to a low power idle mode. If on the other hand a “send status” command signal is received, the controller 114 will activate the transceiver module's 115 transmitter circuit and transmit its unique identifier together with the current meter status data held in local RTU memory 117. RTU controller 111 will then either shut down, or it may be programmed to wait for a “status acknowledged” signal and then shut down.

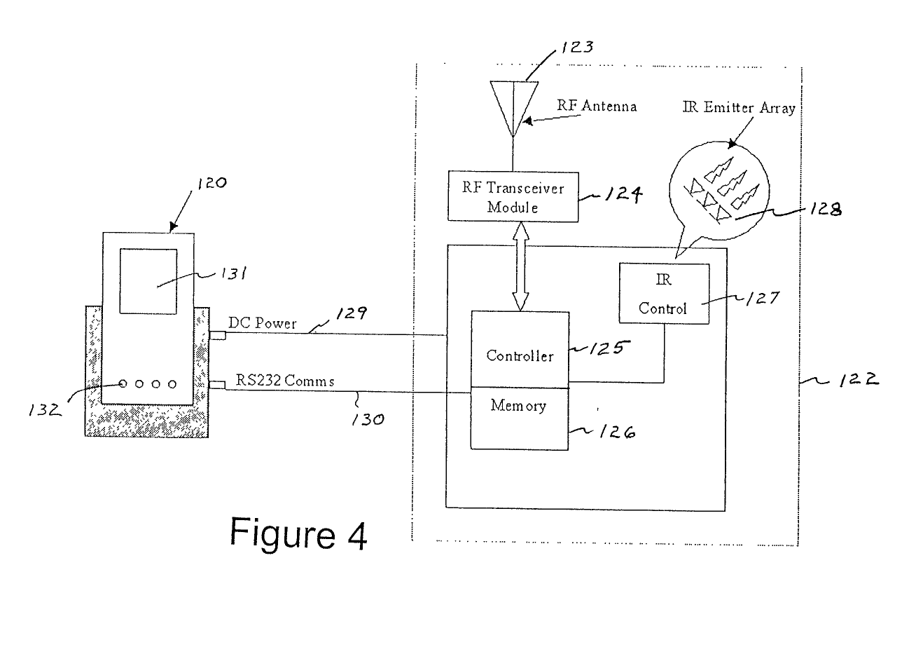

A block diagram of the preferred embodiment of a Mobile Transceiver Unit (MTU) 122 in conjunction with a display unit 120 is shown in FIG. 4. The display unit 120 may be a very simple dash-mounted panel 131 with control keys 132. The panel provides the necessary visual/audible signal indicators for the PEO. For example, lights and audio signaling devices could indicate to the PEO that the meter in question is expired by a red light and a sound at a first frequency, not expired by a green light and a sound at a second frequency, or is receiving a fault reading by a yellow light and a sound at a third frequency. The keys provide the PEO a few basic command options such as 1) Login, 2) System On, 3) System Off.

Alternately the display unit 120 may be a portable data terminal such as a DAP9800 or a palm type Personal Data Assistant (PDA) and will preferably include other functions. These handheld units are designed to be quickly and easily inserted and removed from mating cradles.

The Mobile Transceiver Unit (MTU) 122 is somewhat similar to the RTU 111 in components used. MTU 122 comprises hardware that is placed within the PEO's vehicle 121 and usually on the roof of the vehicle 121. MTU 122 includes an RF antenna 123, an RF transceiver module 124, an intelligent controller 125, a memory 126 and an IR controller 127and emitter array 128. Controller 125 will receive commands from the in-vehicle handheld unit 120, and when directed, will activate the RF transceiver 124 and/or the IR control 127 for modulated IR transmissions from the IR emitter array 128. The emitter array 128 may consist of 3 or more IR emitter devices positioned in a cluster for directing a beam of IR. However, if it is desired to wake-up meters on both sides of a street, an MTU 122 on the vehicle 121 may have two emitter arrays 128, each positioned to point to meters on opposite sides of the street. These IR emitter devices in the arrays 128 are very directional and require a relatively direct and clear “line of sight” path to the RTUs 111.

The RF transceiver module 124 is substantially identical to RF transceiver module 115 in RTU 11. The RF antenna 123 is a small wire antenna that is mounted on the roof of the vehicle 121. Power 129 is provided to both the display unit 120 and MTU 122 from the vehicle 121. A cable 130 connects the display unit 120 to MTU 122 for communication purposes.

The transceiver modules 115, 124 in RTU 111 and MTU 122 respectively are designed for short-range wireless data applications where robust operation, small size and low power consumption are required. The transceivers 115, 124 utilize state of the art amplifier-sequenced hybrid (ASH) architecture to achieve this blend of characteristics. The receiver section of the transceiver module is sensitive and stable. A wide-dynamic-range-log detector provides robust performance in the presence of on-channel interference or noise. Two stages of SAW filtering provide excellent receiver out-of-band rejection. The transmitter includes provisions for both on/off keyed (OOK) and amplitude-shift keyed (ASK) modulation. Other features of the transceiver include support of 2.4-19.2 kbps Encoded Data Transmissions and a 3V, low current operation plus sleep mode.

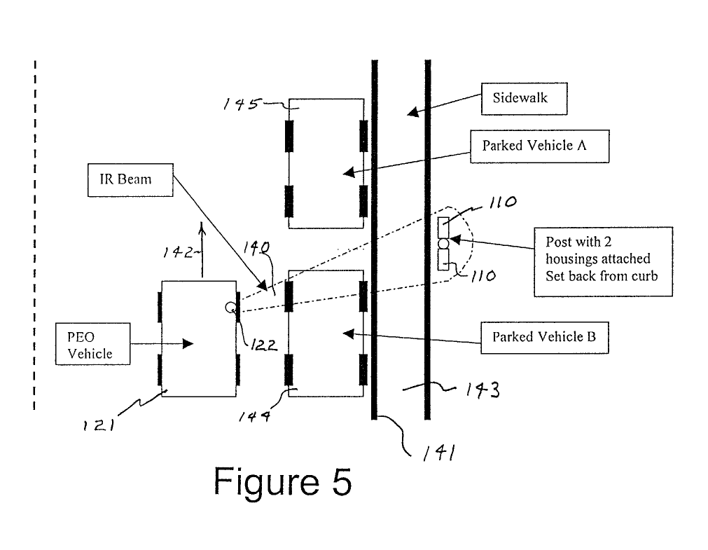

The general operation of the system 10 will be described in conjunction with FIG. 5. As the PEO proceeds on his route, the IR emitter 128 in MTU 122 transmits a very intense, nearly continuous IR modulated burst of IR light in a directed beam 140 towards the curb 141, at an angle of between 45 and 90 degrees from the car's traveling direction 142. At 10 meters, the beam's width would be approximately 4 meters. RF transmissions are also sent out from the MTU 122, however, rather than transmitting continuously, the MTU 122 alternates between transmitting a “send status” command and listening for a response. This is done many times a second. A typical IR illumination of two RTUs 111 by the emitter array 128 as the vehicle 121 moves down the street is illustrated in FIG. 5. In this particular arrangement, the parked cars 144, 145 are positioned next to the curb 141. The corresponding meters 110 are located across the sidewalk 143, with the front of the meter 110 facing the sidewalk 143. As the invisible IR beam 140 emitted from the emitter array 128 illuminates the IR receiver 113 in the RTUI 111, located behind the dome in the parking meter 110 housing, the remote RF transceiver 115 will be activated and will listen for a valid “send status” command, also being transmitted from the MTU 122. Since the MTU 122 is transmitting the “send status” command, the RTU 111 will detect that a PEO's MTU 122 is in the vicinity. Only then will the RTU 111 transmit the meter status kept in the RTU's local memory 117, along with the parking meter's unique meter/post identifier. The MTU 122 will detect the transmission and acknowledge the transmission, so that the meter RTU 111 does not have to retransmit. Since it is quite possible that two parking meters 110 can receive the IR signal at the same time, an anti-collision protocol can be defined to allow for retransmission of the RF status, at different times, should two initial transmissions collide. Alternatively, the meter/post location (left/right) could define which RTU will respond first. This will also be true in systems where an IR beam is being simultaneously transmitted towards meters on both sides of a street.

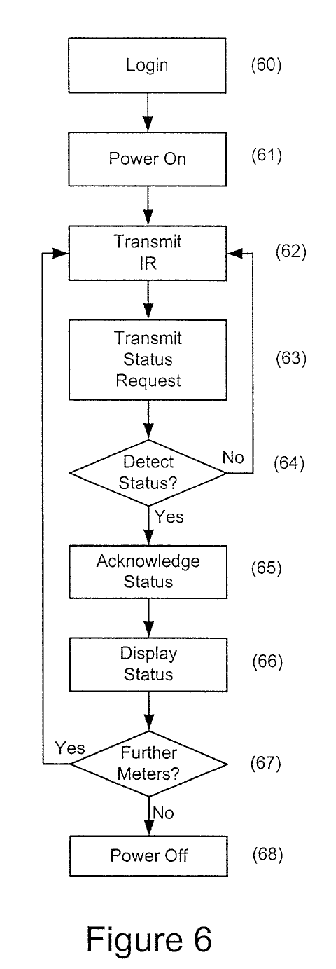

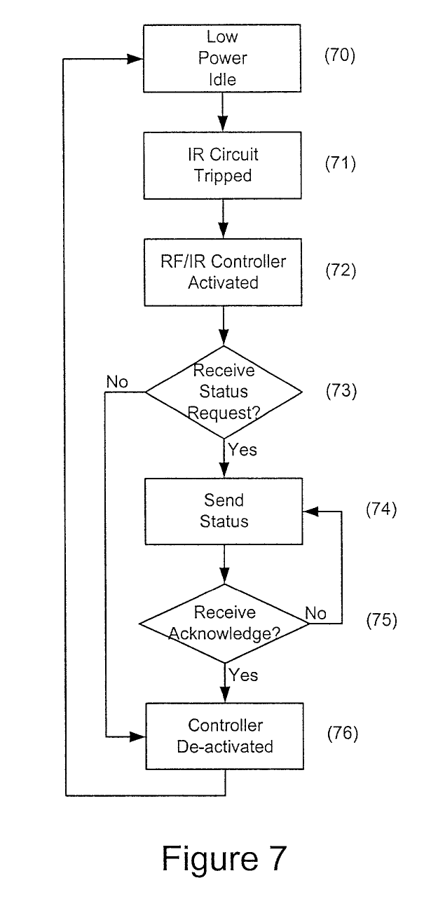

The specific operation of MTU 122 and RTU 111 will be described in conjunction with the flow charts illustrated in FIGS. 6 and 7. On entering the vehicle 121, the PEO will login (60) and power-up (61) the MTU 122 through the control keys 132. Focused bursts of modulated IR radiation is transmitted (62) towards meters 110 along the PEO's route as the vehicle moves down the street. Shortly after the IR radiation, an RF “status request” signal is transmitted (63) towards the meters 110. Controller 125 is programmed to receive and decode a status signal and a unique identifier signal from the meters 110 along the route. When a status signal is detected (64), an “acknowledged status” signal is generated and transmitted (65) to the meter 110 and the display 120 is controlled (66) to display the meter 110 status and the unique meter identifier. If a status signal is not detected (64), further IR bursts are transmitted. Also, if the status of further meters 110 is to be determined (67), then further bursts of IR radiation are transmitted (62) towards the meters 110. However, once the route inspection has been completed, the MTU 122 is powered off (68).

Referring now to the flow chart steps for the RTU 111 illustrated in FIG. 7, the default status of RTUs 111 in meters 110 is the low power idle mode (70). Once the IR circuit 113 has been tripped (71) by the correct modulated IR signal, the intelligent controller 114 on the RTU 111 is activated (72). The controller 114 is an autonomous, low power microprocessor, which controls the response of the RTU 111 to external signals. On activation, and determining that the IR circuit 113 was the source of the wake-up, it then activates the RF transceiver module's 115 receiver section. The purpose of doing this is to determine if a MTU 122 is in the vicinity by listening for a “send status” command signal being transmitted by the MTU 122. Since the RF transceiver module's 115 receiver consumes less power than the transmitter, this sequence reduces unnecessary RF transmissions, conserving battery power. If no command is detected (73) after an appropriate time-out, the controller 114 will shut down (76) the transceiver 115, re-trigger the IR receiver circuit 113, and then go (70) to a low power idle mode. If, however, a “send status” command signal is received (73), the controller 114 will activate the transceiver module's 115 transmitter circuit and transmit (74) its unique identifier together with the current meter status data held in local RTU memory 117. RTU controller 111 is then programmed to wait (75) for a “status acknowledged” signal that will initiate (76) its shut down and place (70) it in the low power idle mode. If however a “status acknowledged” signal is not received after a short period of time, the “status signal” and “unique identifier” will be sent again (75). It is to be noted that the step of receiving a “status acknowledged” signal is optional.

It would be well within the scope of the present invention to incorporate additional features within a fully operational system. These could include a “mute” switch on the display 120 that would turn off or turn down the volume of the audible signal. This would be particularly advantageous in sparsely occupied areas, where the majority of the parking spaces are unoccupied and in violation. In addition, a command like “suspend” would be desirable to stop unnecessary re-broadcast of the IR signal while the PEO is out of the vehicle, issuing a citation/ticket for a meter violation.

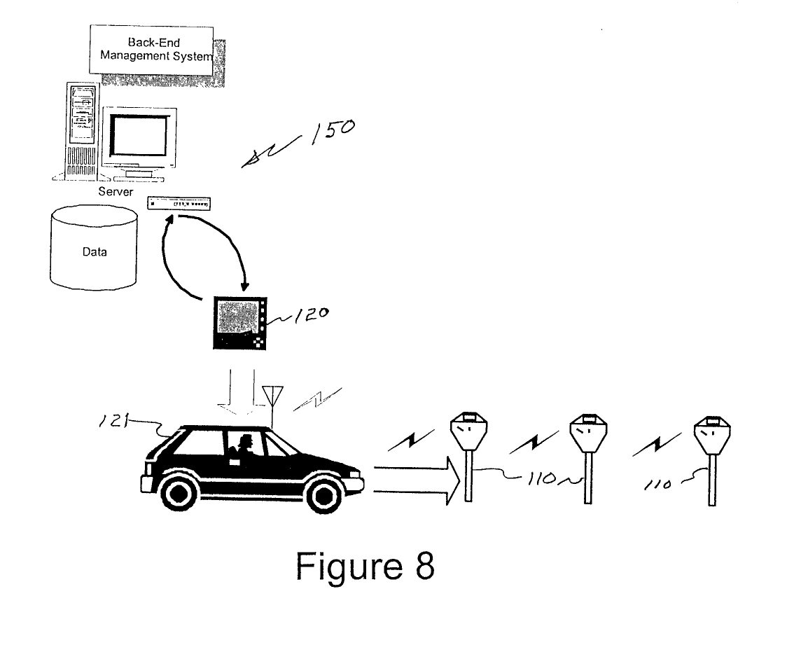

The system as illustrated in FIG. 8 may further include a backend-computer system 150, that would both upload and download operational data from the parking meters 110 through the MTU's 122 in vehicles 121. Such a system 150 could provide a significant amount of operational data to allow the parking authority to more effectively manage the entire parking meter operation. The system 150 could have the ability to easily detect “missed parking meters”, or parking meters that did not report their status as the PEO drove by. This lack of reporting over a period of days could be noted in an exception report and the appropriate maintenance staff sent to investigate the reason. Further, each meter status received could be “time-stamped” allowing the tracking of PEO activities. Other features could include a daily diagnostic from the meter mechanism or a time stamp placed on each status held in the RTU 111. This would ensure that the same, unchanged status over a period of days is detected, investigated, and corrected.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A system for remotely determining the status of parking meters having remote units for the meters and a mobile unit for interrogating the remote units wherein the remote unit comprises:
receiver means for receiving a wake-up signal;
transceiver means for transmitting and receiving command signals; and
controller means for operating the receiver means and the transceiver means; and
wherein the mobile unit comprises:
transmitter means for transmitting the wake-up signal;
transceiver means for transmitting and receiving command signals;
display means for indicating the status of a meter; and
controller means for operating the transmitter means, the transceiver means and the display means.

2. A system for remotely determining the status of parking meters as claimed in claim 1 wherein the remote unit further comprises memory means for storing meter status.

3. A system for remotely determining the status of parking meters as claimed in claim 1 wherein a remote unit is associated with each meter.

4. A system for remotely determining the status of parking meters as claimed in claim 1 wherein the memory means stores a meter identifier.

5. A system for remotely determining the status of parking meters as claimed in claim 1 wherein the remote unit receiver means is an infrared receiver and the mobile unit transmitter means is an infrared transmitter.

6. A system for remotely determining the status of parking meters as claimed in claim 5 wherein the infrared transmitter comprises an infrared controller and an infrared emitter array for transmitting a focussed infrared beam.

7. A system for remotely determining the status of parking meters as claimed in claim 5 wherein the infrared transmitter comprises an infrared controller and an infrared emitter array for transmitting focussed infrared beams in one or more different directions.

8. A system for remotely determining the status of parking meters as claimed in claim 1 wherein the remote transceiver means and the mobile transceiver means are RF transceivers.

9. A system for remotely determining the status of parking meters as claimed in claim 1 wherein the display means comprises light means for indicating meter status and control keys for interfacing with the controller means.

10. A system for remotely determining the status of parking meters as claimed in claim 9 wherein the display means comprises audio means for indicating meter status.

11. A system for remotely determining the status of parking meters as claimed in claim 3 wherein the remote unit is located in the meter housing.

12. A system for remotely determining the status of parking meters as claimed in claim 11 wherein the mobile unit is located in a vehicle.

13. A system for remotely determining the status of parking meters as claimed in claim 1 wherein the mobile unit comprises memory means coupled to the controller means for storing data in the mobile unit, and the system comprises a back-end data processing system for transmitting data to the mobile unit and for receiving data from the mobile unit.

14. In a system for remotely determining the status of parking meters having remote unit for the meters and a mobile unit for interrogating the remote unit wherein each remote unit comprises:
receiver means for receiving a wake-up signal;
transceiver means for transmitting and receiving command signals; and
controller means for operating the receiver means and the transceiver means.

15. In a system as claimed in claim 14 wherein each unit comprises memory means for storing the status and identifier of a meter.

16. In a system as claimed in claim 15 wherein the remote unit is located in the meter housing

17. A remote unit as claimed in claim 14 wherein the remote unit receiver means is an infrared receiver.

18. A remote unit as claimed in claim 14 wherein the remote transceiver means is an RF transceiver.

19. In a system for remotely determining the status of parking meters having remote units for the meters and a mobile unit for interrogating the remote unit wherein the mobile unit comprises:
transmitter means for transmitting a wake-up signal;
transceiver means for transmitting and receiving command signals;
display means for indicating the status of a meter; and
controller means for operating the transmitter means, the transceiver means and the display means.

20. A mobile unit as claimed in claim 19 wherein the mobile unit transmitter is an infrared transmitter.

21. A mobile unit as claimed in claim 20 wherein the infrared transmitter comprises an infrared controller and an infrared emitter array for transmitting a focussed infrared beam.

22. A mobile unit as claimed in claim 20 wherein the infrared transmitter comprises an infrared controller and an infrared emitter array for transmitting focussed infrared beam in one or more different directions

23. A mobile unit as claimed in claim 19 wherein the mobile transceiver means is an RF transceiver.

24. A mobile unit as claimed in claim 19 wherein the display means comprises light means for indicating meter status and control keys for interfacing with the controller means.

25. A mobile unit as claimed in claim 24 wherein the display means comprises audio means for indicating meter status.

26. A mobile unit as claimed in claim 19 wherein the mobile unit is located in a vehicle.

27. A mobile unit as claimed in claim 19 wherein the mobile unit comprises a memory means coupled to the controller means for storing data in the mobile unit.

28. A method of determining the status of parking meters in a system having a number of remote units for the meters and a mobile unit for interrogating the remote units, comprising the steps of:
a.1) transmitting a wake-up signal to a remote unit from the mobile unit;
b.1) receiving a meter status signal from the remote unit; and
c.) displaying the status of the meter at the mobile unit.

29. A method as claimed in claim 28 wherein step a.1) is followed by:
a.2) transmitting a status request signal to the remote unit from the mobile unit.

30. A method as claimed in claim 29 wherein step b.1) includes receiving the meter unique identifier signal with the status signal.

31. A method as claimed in claim 29 wherein step b.1) is followed by:
b.2) transmitting a status acknowledged signal from the mobile unit to the remote unit.

32. A method as claimed in claim 28 wherein the wake-up signal is a focused infrared beam.

33. A method as claimed in claim 28 wherein the wake-up signal is a focused ultrasonic beam.

34. A method as claimed in claim 28 wherein the wake-up signal is a focused RF beam.

35. A method as claimed in claim 28 wherein the wake-up signal is a number of focused infrared beams transmitted in one or more different directions.

36. A method as claimed in claim 31 wherein steps a.2), b.1) and b.2) are transmitted by RF.

37. A method as claimed in claim 30 wherein step c.) includes displaying the meter unique identifier.
